(19) United States
(12) Patent Application Publication
(10) Pub. No.: US 2023/0234254 A1
(43) Pub. Date: Jul. 27, 2023

(54) APPARATUS AND METHOD FOR CUTTING A SUBSTRATE

(71) Applicant: The Procter & Gamble Company, Cincinnati, OH (US)

(72) Inventors: Dale Francis BITTNER, Harrison, OH (US); James William BUSCH, Maineville, OH (US)

(21) Appl. No.: 18/098,781

(22) Filed: Jan. 19, 2023

(30) Foreign Application Priority Data
Jan. 25, 2022 (EP) 22153098.3

(51) Int. Cl. B26D 7/20; B26D 1/00; B26D 7/26; B26D 1/62; B26D 1/58

(52) U.S. Cl. CPC B26D 7/204; B26D 1/0006; B26D 7/2628; B26D 1/626; B26D 1/585

(57) ABSTRACT

The present invention relates to an apparatus and a process for cutting a substrate wherein the apparatus comprises first and second cutting element and wherein the first and second cutting elements are rotatable about the axis of rotation at different circumferential speeds.

### FIELD OF THE INVENTION

The present disclosure is directed to apparatuses and methods for separating discrete articles from substrates such as continuous webs.

### BACKGROUND OF THE INVENTION

Articles, such as absorbent articles, are sometimes produced on a continuous manufacturing line. Initially, a continuous base web may be conveyed down the manufacturing line and various components may be added to it. At the point in the manufacturing line where the articles are in final form, or a semi-finished form, it may be desirable to separate discrete articles from the continuous webs so that they can be processed for packaging or further manufacturing, for example. Typically, an anvil roll is paired with a cutting roll having a knife to cut the continuous webs.

Furthermore, in the conventional anvil roll/cutting roll set-up, the cutting roll and/or anvil roll is usually changed out each time a different size (or pitch) of article is desired to be cut. For example, when running a first article with a pitch (i.e., machine direction length) of 200 mm, the cutting roll and/or the anvil are usually changed out to run a second article with a pitch of 300 mm. This can lead to costly downtime. Furthermore, conventional anvil roll/cutting rolls assemblies have a problem with roll parallelism and center-to-center distances which may cause issues with cuts or separation of the continuous webs.

In view of the foregoing, methods and apparatuses for separating discrete articles from a web of the articles should be improved.

### SUMMARY OF THE INVENTION

In one embodiment the present invention relates to apparatus for cutting a substrate, wherein the apparatus comprises at least a first cutting element, a second cutting element and an anvil, wherein the first and second cutting elements are mounted around an axis of rotation and wherein cutting edges of the first and second cutting elements are substantially parallel and the cutting edges of the first and second cutting elements define a cutting circumference which is immediately adjacent to, or intersects with, a surface of the anvil, wherein the first cutting element and the second cutting element are rotatable about the axis of rotation at different circumferential speeds so that the distance about the cutting circumference between the first cutting element and the second cutting element is a variable circumferential distance.

In a further embodiment the present invention relates to a process for cutting a continuous substrate into discrete pieces on the surface of an anvil, the process comprising the steps of: rotating a first cutting element about an axis of rotation at a first variable circumferential speed, and rotating a second cutting element about the axis of rotation at a second circumferential speed which is a variable circumferential speed independently controllable to the first circumferential speed; wherein cutting edges of the first and second cutting elements are oriented to define a cutting circumference which is immediately adjacent to, or intersects with, the surface of the anvil.

### BRIEF DESCRIPTION OF DRAWINGS

FIG. 1 shows a section of an anvil and a cutting tool of the present invention;

FIG. 2 shows a perspective view of an apparatus of the present invention;

FIG. 3 shows an apparatus of the present invention;

FIG. 4A shows a side view of a cutting tool of the present invention;

FIG. 4B shows a front view of a cutting tool of the present invention;

FIG. 5A shows a side view of a cutting head assembly of the present invention;

FIG. 5B shows a front view of a cutting head assembly of the present invention;

FIG. 6 shows a perspective view of an alternative embodiment of the apparatus of the present invention;

FIG. 7 shows a front view of alternative cutting head assembly of the present invention.

### DETAILED DESCRIPTION OF THE INVENTION

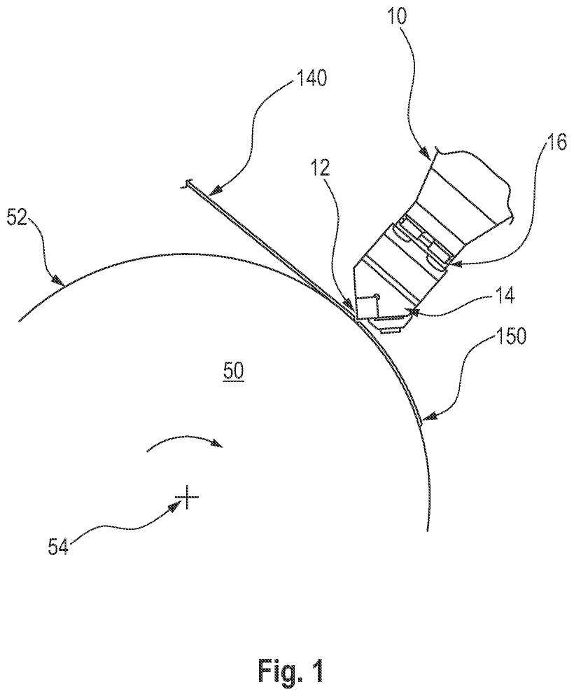

Referring to FIG. 1, a substrate 140 is continuously fed onto an anvil surface 52 to a cutting region at which the substrate 140 is cut into discrete patches 150. Preferably the substrate 140 is a continuous web of material, more preferably a nonwoven web, film, or composite thereof. In one embodiment of the invention the discrete patches 150 may be held against the anvil surface 52 by means of vacuum. The anvil surface 52 may be provided with perforations 56 and vacuum may be applied through the perforations 56 by reducing the pressure within the drum of the anvil 50.

In the cutting region the cutting edge of the cutting element 12 is immediately adjacent to, or intersects with, a surface of the anvil 52 so that the cutting element 12 cuts through the web material 140. The cutting element 12 is securely mounted in the support block 14, which in turn is connected to support arm 10 by means of a column support element 16.

Still referring to FIG. 1, the anvil is rotated about axis of rotation 54. The support arm is rotated so that, in the cutting region, the circumferential speed of the anvil surface and the circumferential speed of cutting element 12 are substantially matched during the short cutting section of the process. Matching or substantially matching these speeds helps to reduce wear on the apparatus in general and on the cutting element 12 and anvil surface 52 in particular.

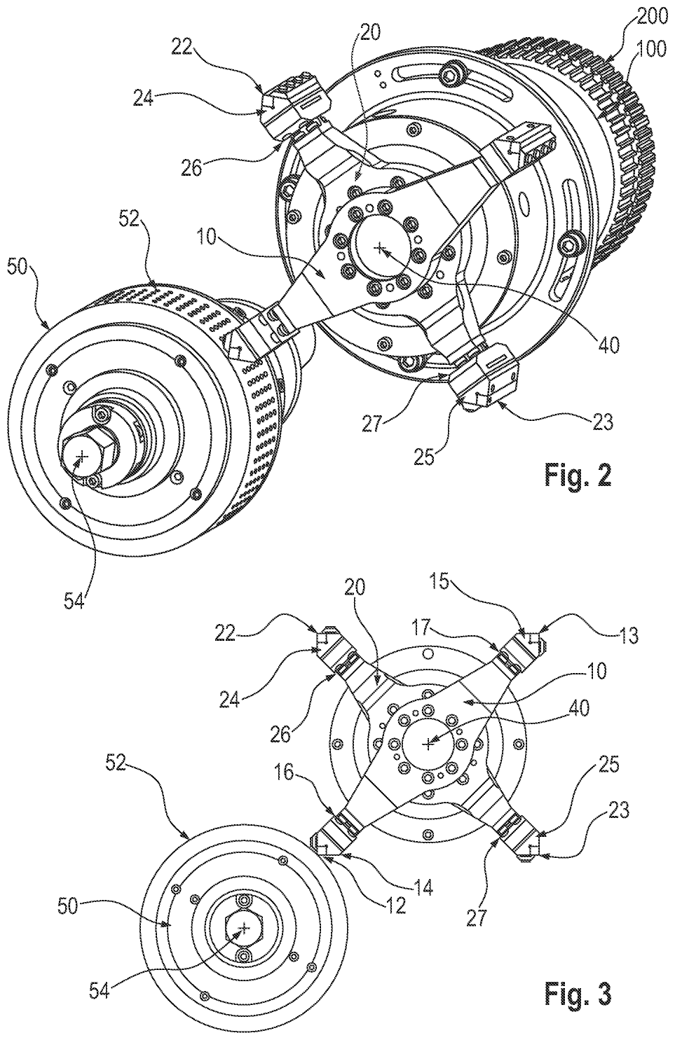

Referring to FIGS. 2 and 3, the embodiment shown comprises two pairs of cutting elements: first pair of cutting elements 12, 13 and second pair of cutting elements 22, 23. The first pair of cutting elements 12, 13 are mounted on opposing ends of first support arm 10 which is rotatable about axis of rotation 40. The first support arm is driven by means of a first drive shaft (not shown) connected to first synchronous drive pulley 100. Correspondingly, the second pair of cutting elements 22, 23 are mounted on opposing ends of second support arm 20 which is rotatable about axis of rotation 40, drive by synchronous drive pulley 200. The second support arm 20 is driven by means of a second drive shaft (not shown) connected to second synchronous drive pulley 100. The first drive shaft and the second drive shaft drive the first support arm and the second support arm about common axis of rotation 40.

Whilst the embodiment illustrated in FIGS. 2 and 3 shows cutting elements operatively connected in pairs by means of a support arm, it is equally possible for cutting blades to be mounted individually, one cutting element per support arm, or for multiple cutting elements, e.g. three, four or more cutting elements to be operatively connected by means of a support arm. In the embodiment in which a single cutting element is mounted on a support arm, it is preferred to mount a counter-balancing weight on the support arm on the opposite side of the axis of rotation for balance of the cutting tool. In the embodiments in which three, four or more cutting elements are mounted on a support arm, it is preferred that the cutting elements are equally spaced around the circumference.

Still referring to FIGS. 2 and 3, the first cutting elements 12, 13 and the second cutting elements 22, 23 are rotatable about the axis of rotation 40 at different circumferential speeds so that the distance about the cutting circumference between the first cutting elements 12, 13 and the second cutting elements 22, 23 is a variable circumferential distance. Preferably this is achieved by driving the first support arm and the second support arm at cyclically variable speeds of rotation. For example, a graphical representation of the rotational speed of the support arm may be a sinusoidal cycle. More preferably the variable speed is provided and controlled by one or more servomotors provided to synchronous drive pulleys 100, 200.

In FIGS. 2 and 3, two support arms 10, 20 carrying two pairs of cutting elements 12, 13, 22, 23, are illustrated. However in other embodiments within the scope of the invention, three, four or more support arms may be mounted on three, four or more drive shafts and support arms may be provided carrying multiple cutting elements.

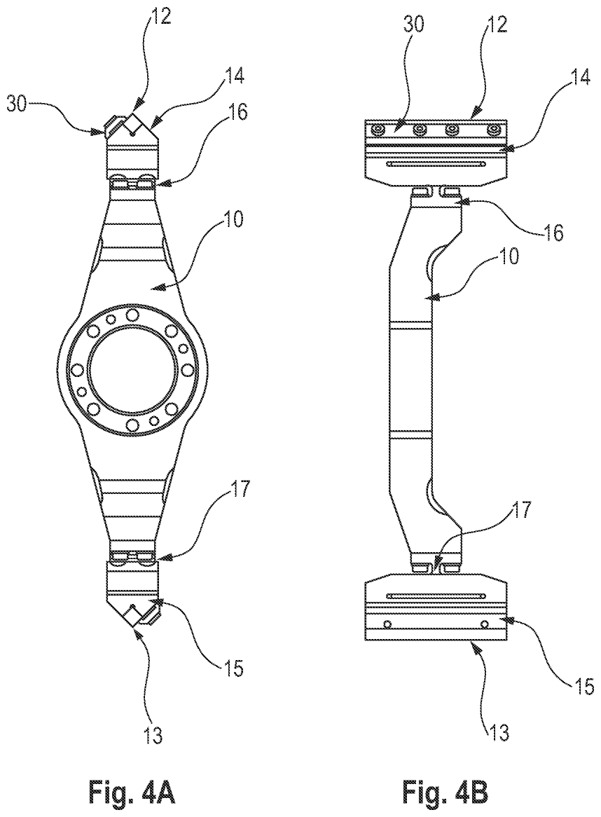

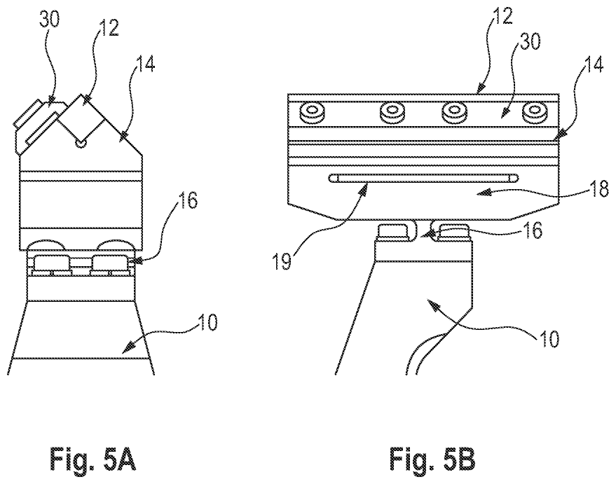

Referring to FIGS. 4A and 4B a single support arm 10 supporting a pair of opposed cutting elements 12, 13 is illustrated. Each cutting element 12, 13 is securely mounted in a support block 14, 15 by means of blade clamp 30. The support block 14, 15 is, in turn, connected to support arm 10 by means of a column support element 16, 17. Referring to FIGS. 5A and 5B the support block 14 can be provided with a geometry that facilitates movement of cutting element 12 due to compressionary forces exerted upon cutting element 12 by rotary anvil 50. In other words, as rotary anvil 50 contacts cutting element 12 and any web material disposed therebetween, rotary anvil 50 caused cutting element 12 to deflect away from rotary anvil 50 in a direction generally orthogonal to cutting element 12. The movement of cutting element 12 away from rotary anvil 50 requires the cutting elements 12, 13, 22, 23 to have radial compliance, which ensures reliable cutting and reduces tooling wear. This radial compliance may be provided by flexible compliance element 18. Further, parallel compliance may be provided by flexible column support element 16, 17 which helps to ensure that cutting elements 12, 13, 22, and 23 remain parallel to the anvil surface 52 during the cutting process.

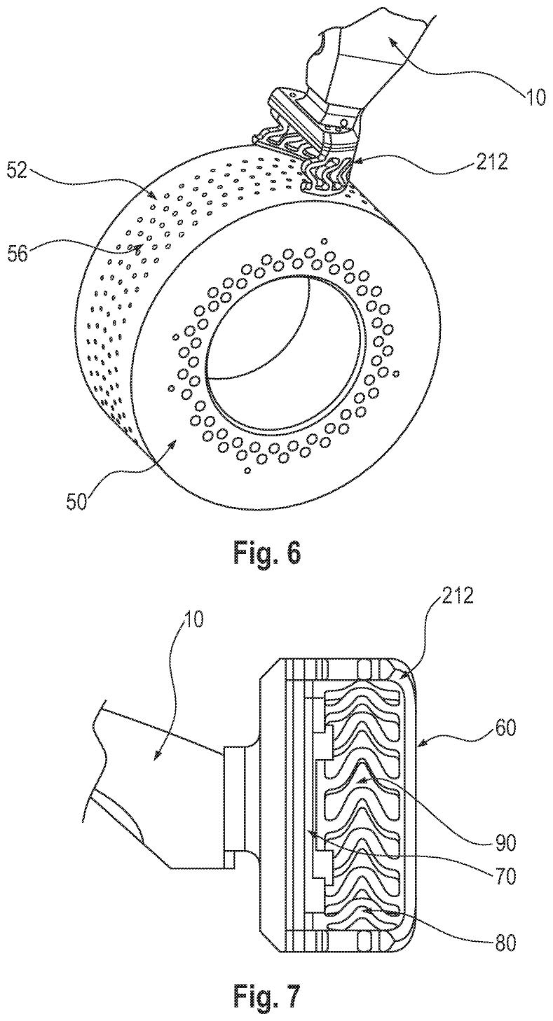

Referring to FIGS. 6 and 7, the cutting element may be a curvilinear cutting element 212. The curvilinear cutting edge makes a non-linear cut through the continuous web 140. Curvilinear cutting elements are disclosed in detail in U.S. Pat. No. 10,807,263, issued on Oct. 20 2020, incorporated herein by reference.

The cutting element 212 can be thought of as comprising a cutting edge 60, a fixed edge 70, and a plurality of flexible beam elements 80 connecting the cutting edge 60 and the fixed edge 70. The beam elements 80 act to transfer force between the fixed edge 70 and the cutting edge 60. Each beam element 80 is separated from adjacent beam elements 80 by a reduced stiffness zone 90. The beam elements 80 are defined by the material between the reduced stiffness zones 90.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. An apparatus for cutting a substrate, wherein the apparatus comprises at least a first cutting element (12), a second cutting element (22) and an anvil (50), wherein the first and second cutting elements (12, 22) are mounted around an axis of rotation (40) and wherein cutting edges of the first and second cutting elements (12, 22) are substantially parallel and the cutting edges of the first and second cutting elements (12, 22) define a cutting circumference which is immediately adjacent to, or intersects with, a surface (52) of the anvil (50),
wherein the first cutting element (12) and the second cutting element (22) are rotatable about the axis of rotation (40) at different circumferential speeds so that the distance about the cutting circumference between the first cutting element (12) and the second cutting element (22) is a variable circumferential distance.

2. The apparatus according to claim 1 further comprising:
a first pair of cutting elements (12, 13) mounted equidistantly on opposite side of the axis of rotation (40); and
a second pair of cutting elements (22, 23) mounted equidistantly on opposite sides of the axis of rotation (40).

3. The apparatus according to either of the previous claims wherein:
the first cutting element (12) is mounted on a first arm (10), and wherein the first arm (10) is rotated by a first synchronous drive shaft;
the second cutting element (22) is mounted on a second arm (20), and wherein the second arm (20) is rotated by a second synchronous drive shaft; and
wherein the first and second synchronous drive shafts are mounted concentrically about axis of rotation (40).

4. The apparatus according to any of the previous claims wherein:
each cutting element (12, 22) is connected by one or more flexible elements to each arm (10, 20), and wherein each of the flexible elements deflects or deforms at the point where the cutting element (12, 22) is immediately adjacent to, or intersects with, the surface (52) of the anvil (50).

5. The apparatus according to claim 4 wherein:
the flexible element is selected from the group consisting of: a flexible compliance element (18); a flexible column support element (16, 17); a flexible beam element (80); and combinations thereof.

6. The apparatus according to any of the previous claims wherein the cutting edge of the cutting element (212) has a curvilinear profile.

7. The apparatus according to claim 6 wherein the cutting element (212) is mounted on a plurality of flexible beam elements (80).

8. A process for cutting a continuous substrate (140) into discrete pieces (150) on the surface (52) of an anvil (50), the process comprising the steps of:
rotating a first cutting element (12) about an axis of rotation (40) at a first variable circumferential speed, and
rotating a second cutting element (22) about the axis of rotation (40) at a second circumferential speed which is a variable circumferential speed independently controllable to the first circumferential speed;
wherein cutting edges of the first and second cutting elements (12, 22) are oriented to (12, 22) define a cutting circumference which is immediately adjacent to, or intersects with, the surface (52) of the anvil (50).

9. The process of claim 8, further comprising the step of:
controlling the circumferential speed of the first cutting element (12) by mounting the first cutting element (12) on a first arm (10), the first arm (10) being rotated by a first synchronous drive shaft, and
independently controlling the circumferential speed of the second cutting element (22) by mounting the second cutting element (22) on a second arm (20), the second arm (20) being rotated by a second synchronous drive shaft.

10. The process according to claim 8 or 9, further comprising the step of:
operatively connecting each cutting element (12, 22) to each respective arm (10, 20) by one or more flexible elements, and
deforming or deforming each of the flexible elements at the point where the cutting element (12, 22) is immediately adjacent to, or intersects with, the surface (52) of the anvil (50).
